(19) United States
(12) Patent Application Publication
(10) Pub. No.: US 2014/0142228 A1
(43) Pub. Date: May 22, 2014

(54) Plasticized, Conductive Polyoxymethylene for Fuel Applications

(71) Applicant: Ticona LLC, Florence, KY (US)

(72) Inventors: Jeremy Hager Klug, Union, KY (US); Dwight D. Smith, Milton, IN (US); Oliver Juenger, Mainz (DE)

(73) Assignee: Ticona LLC, Florence, KY (US)

(21) Appl. No.: 14/065,515

(22) Filed: Oct. 29, 2013

Related U.S. Application Data
(60) Provisional application No. 61/728,869, filed on Nov. 21, 2012.
(60) Provisional application No. 61/774,965, filed on Mar. 8, 2013.

(51) Int. Cl. C08L 61/00

(52) U.S. Cl. CPC C08L 61/00
USPC 524/169; 524/542; 524/424

(57) ABSTRACT

Polymer compositions containing a plasticized, impact modified polyoxymethylene composition that is compounded with a conductive filler composition are disclosed that are flexible while also exhibiting electrostatic dissipative (ESD) capabilities. The polymer compositions can be formed into shaped articles such as tubes, hoses, etc. for use in fuel transfer systems. The plasticized, impact modified polyoxymethylene composition includes a functionalized polyoxymethylene, a plasticizer, and an impact modifier. Meanwhile, the conductive filler composition includes a conductive filler and a high flow polyoxymethylene. The compositions can be compounded into a pellet product which can then be formed into a shaped article that complies with the ESD capabilities required by SAE J1645. It is also to be understood that the polymer composition components can be blended and formed into a pellet product in a single step that can be used to produce a shaped article that complies with the ESD capabilities required by SAE J1645.

### RELATED APPLICATIONS

The present application claims priority to U.S. Provisional Application Ser. Nos. 61/728,869, filed on Nov. 21, 2012, and 61/774,965, filed on Mar. 8, 2013, which are incorporated herein in their entirety by reference thereto.

### BACKGROUND OF THE INVENTION

Polyacetal polymers, which are commonly referred to as polyoxymethylene polymers, have become established as exceptionally useful engineering materials in a variety of applications. Polyoxymethylene polymers, for instance, are widely used in constructing molded parts, such as parts for use in the automotive industry and the electrical industry. Polyoxymethylene polymers have excellent mechanical properties, fatigue resistance, abrasion resistance, and chemical resistance.

Although polyoxymethylene polymers have excellent physical characteristics, the polymers may not be suitable components in certain applications, such as in fuel transfer applications, where the risk of a spark or explosion is increased. Because the electrical resistances within plastics such as polyoxymethylene are usually very high, there is a risk of electrostatic charging, which can be disruptive and even dangerous in certain application sectors, such as in the fuel and automotive sectors. This risk is due to the inability of the polymers to dissipate electrical charge. For instance, unlike metallic components, which provide an electrical pathway for electrical charges to move freely to ground, when a non-conductive, plastic component is used, such a pathway is removed, leaving no way for charges to drain to ground. This, in turn, creates a risk of sparking or explosion when a plastic component is used. Further, while polyoxymethylene polymers exhibit excellent stability and chemical resistance when exposed to harsh chemical such as fuel, such polymers may not have enough flexibility to be suitable for compression loaded pipes, tubes, or hoses that are required in fuel transfer applications.

In view of the above, a need exists for a flexible polyoxymethylene polymer composition that also has ESD capabilities and to articles formed from such a composition.

### SUMMARY OF THE INVENTION

Generally speaking, the present disclosure is directed to a flexible polymer composition that exhibits electrostatic dissipative (ESD) capabilities. The polymer composition can be formed into an article through any suitable molding process such as injection molding, extrusion, blow molding, or deep drawing and extrusion blow molding. The molded article can be formed, for instance, into any suitable shape, such as a cable, pipe, tube, corrugated pipe, fuel pipe, fuel hose, brake hose, or connection assembly.

Of particular advantage, the polymer composition of the present disclosure includes a plasticized, impact modified polyoxymethylene polymer composition blended with a conductive filler composition such that the polymer composition has ESD capabilities. More specifically, the polymer composition comprises a plasticized, impact modified polyoxymethylene composition comprising a first polyoxymethylene polymer having terminal groups, wherein at least about 25% of the terminal groups in the first polyoxymethylene polymer are functional groups; a plasticizer; and an impact modifier; and a conductive filler composition blended with the plasticized, impact, modified polyoxymethylene composition, the conductive filler composition comprising a conductive filler and a second polyoxymethylene polymer.

The functional groups of the first polyoxymethylene polymer can be hydroxyl groups, and the first polyoxymethylene polymer can be present in the polymer composition in an amount ranging from about 30% by weight to about 95% by weight based on the total weight of the polymer composition.

Meanwhile, the plasticizer can be an aliphatic or aromatic ester comprising an adipate, a sebacate, a maleate, a phthalate, a trimellitate, a benzoate, or combinations thereof. For instance, the plasticizer can be a sulfonamide such N-(n-butyl)benzene sulfonamide. The plasticizer can be present in the polymer composition in an amount ranging from about 2.5% by weight to about 40% by weight based on the total weight of the polymer composition.

Further, the impact modifier can comprise a thermoplastic elastomer. In one embodiment, the thermoplastic elastomer can be a thermoplastic polyurethane elastomer. The impact modifier can be present in the polymer composition in an amount ranging from about 5% by weight to about 50% by weight based on the total weight of the polymer composition.

In still another embodiment, the plasticized, impact modified polyoxymethylene composition further comprises a coupling agent. In one embodiment, the coupling agent can comprise an isocyanate. The coupling agent can be present in the composition in an amount ranging from about 0.1% by weight to about 10% by weight.

In addition, the conductive filler can comprise a metal powder, metal flakes, metal fibers, carbon powder, carbon fibers, carbon black, carbon nanotubes, or combinations thereof. For instance, the conductive filler can comprise stainless steel fibers in one embodiment and carbon nanotubes in still another embodiment. The conductive filler can be present in the polymer composition in an amount ranging from about 1% by weight to about 30% by weight based on the total weight of the polymer composition.

The second polyoxymethylene composition that is blended with the conductive filler to form the conductive filler composition can have a melt flow rate of from about 2.5 grams per 10 minutes to about 55 grams per 10 minutes at 190° C. and a 2.16 kilogram load, such as from about 9 grams per 10 minutes to about 45 grams per 10 minutes at 190° C. and a 2.16 kilogram load. The second polyoxymethylene composition can be present in the polymer composition in an amount ranging from about 1% by weight to about 30% by weight based on the total weight of the polymer composition.

The aforementioned polymer composition can be used to form a shaped article such as a fuel line or a tube. Further, the tube can be a corrugated tube.

The polymer composition can be used to form a molded article. Molded articles made according to the present disclosure may be used in numerous different fields. For instance, the molded product may be used in the automotive and fuel industries in any application where ESD capabilities are needed, such as tubes or hoses for fuel lines and transfer pipes where dissipation of electrical charge is required to reduce the risk of explosion due to charge build.

In another embodiment, the polymer composition of the present disclosure comprises a first polyoxymethylene polymer having terminal groups, wherein at least about 25% of the terminal groups in the first polyoxymethylene polymer are functional groups; a plasticizer; an impact modifier; a conductive filler; and a second polyoxymethylene polymer. The first polyoxymethylene polymer can be present in an amount ranging from about 30% by weight to about 95% by weight, the plasticizer can be present in an amount ranging from about 2.5% by weight to about 40% by weight, the impact modifier can be present in an amount ranging from about 5% by weight to about 50% by weight, the conductive filler can be present in an amount ranging from about 1% by weight to about 30% by weight, and the second polyoxymethylene polymer can be present in an amount ranging from about 1% by weight to about 30% by weight, based on the total weight of the polymer composition. In one embodiment, the second polyoxymethylene polymer has a melt flow rate of from about 2.5 grams per 10 minutes to about 55 grams per 10 minutes at 190° C. and a 2.16 kilogram load. The polymer composition can further comprise a coupling agent that is present in an amount ranging from about 0.1% by weight to about 10% by weight based on the total weight of the polymer composition.

Other features and aspects of the present disclosure are discussed in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 shows a corrugated tube made of the polymer composition of the present disclosure; and

FIG. 2 shows a fuel system utilizing a corrugated tube made of the polymer composition of the present disclosure.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer composition that is well suited to being molded into articles having exceptional fuel performance characteristics in addition to increased yield strain and flexibility. The present disclosure is also directed to a process for producing molded parts containing such a polymer composition. The composition is formulated so as to increase the electrostatic dissipative (ESD) capabilities of the composition sufficient to satisfy SAE J1645 material and part requirements for conductivity of plastic materials for use in fuel systems. For instance, articles formed from the polymer composition of the present disclosure can have a volume resistivity of less than 10⁶ Ohm-cm. As such, the polymer composition can be molded into articles for use in fuel transfer applications.

More particularly, the polymer composition of the present disclosure comprises a plasticized, impact modified polyoxymethylene composition that is compounded with a conductive filler composition to form a pelleted product that can then be formed into a molded article. The combination of the plasticized, impact modified polyoxymethylene composition with the conductive filler composition has been found to improve the ESD capabilities of articles made from impact-modified polyoxymethylene, and thus the polymer composition of the present disclosure is suitable for use in applications where dissipation of electric charge is desired. For instance, the polymer composition of the present disclosure can be used to form flexible tubes for use in fuel lines or other fuel delivery parts. In addition to being used to form such monolayer tubes, the polymer composition of the present disclosure can also be used in multilayer tubes where the inner layer comprises the polymer composition of the present disclosure because ESD capabilities are needed and the exterior layer comprises a composition having different material properties such as impact resistance, permeation resistance, or salt resistance. Such multilayer applications include ties layers, permeation block layers, etc. Components of the polymer composition are discussed in more detail below. Generally, the polymer composition results from the combination of a plasticized, impact modified polyoxymethylene composition with a conductive filler composition.

The components of the plasticized, impact modified polyoxymethylene composition are now discussed. First, the polyoxymethylene polymer contained in the plasticized, impact modified polyoxymethylene composition has a relatively high number of functional groups. For example, at least about 25%, such as at least about 50%, such as at least about 60%, such as at least about 70%, such as at least about 80% of the terminal groups on the polyoxymethylene polymer are functional groups.

In one embodiment, the polyoxymethylene polymer includes a significant number of hydroxyl groups in the terminal position. For instance, in one embodiment, ether end groups on the polyoxymethylene polymer can be replaced with ethoxy hydroxy end groups. The hydroxyl group content of the resulting polyoxymethylene polymer (POM-OH) can be further increased by using a comonomer with hydroxyl side chains. The hydroxyl group concentration may also be increased through the use of a polyoxymethylene moiety with a dendrimer structure. The polyoxymethylene polymer can include more than 20 hydroxyl groups per chain, such as more than 25 hydroxyl groups per chain. In one embodiment, for instance, the polyoxymethylene polymer may include from about 20 hydroxyl groups per chain to about 50 hydroxyl groups per chain.

More particularly, the polyoxymethylene polymer can have terminal hydroxyl groups, for example, hydroxyethylene groups and/or hydroxyl side groups in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. In another embodiment, the polyoxymethylene polymer can have other terminal groups, such as alkoxy groups, formate groups, acetate groups, or aldehyde groups. It should be understood that the total number of terminal groups present includes all side terminal groups. The functionalized polyoxymethylene can be present in the polymer composition in an amount ranging from about 30% by weight to about 95% by weight, such as in an amount ranging from about 40% by weight to 90% by weight, such as in an amount ranging from 50% by weight to about 85% by weight based on the total weight of the polymer composition.

As described above, the polyoxymethylene composition further comprises a plasticizer to increase its flexibility. The plasticizer can be, for example, a sulfonamide. The plasticizer can be present in the polymer composition in an amount ranging from about 2.5% by weight to about 40% by weight, such as in an amount ranging from about 5% by weight to about 35% by weight, such as in an amount ranging from about 10% by weight to about 25% by weight based on the total weight of the polymer composition.

Additionally, the polyoxymethylene composition comprises an impact modifier to improve the impact resistance of the finished product to resist sudden pulses or shocks. The impact modifier can be a thermoplastic elastomer. The thermoplastic elastomer may comprise, for instance, a thermoplastic polyurethane elastomer and/or a polyester elastomer. The thermoplastic elastomer can be present in the polymer composition in an amount ranging from about 2.5% by weight to about 40% by weight, such as in an amount ranging from about 5% by weight to about 35% by weight, such as in an amount ranging from about 10% by weight to about 25% by weight based on the total weight of the polymer composition. The thermoplastic elastomer may be chemically bonded to the polyoxymethylene polymer such as via a coupling agent.

As such, the polyoxymethylene composition can further comprise a coupling agent to provide a linkage between the nucleophilic groups in the molding composition. The coupling agent, for instance, may comprise an isocyanate. The coupling agent may be present in the polymer composition in an amount ranging from about 0.1% by weight to about 10% by weight, such as in an amount ranging from about 0.2% by weight to about 5% by weight, such as in an amount ranging from about 0.5% by weight to about 2.5% by weight based on the total weight of the polymer composition.

In addition to the plasticized, impact modified polyoxymethylene composition discussed above, the polymer composition of the present disclosure further comprises a conductive filler composition that is compounded with a high-flow polyoxymethylene composition.

The conductive filler can include conductive particles, powders, fibers or combinations thereof. For instance, the conductive filler may comprise metal powders, metal flakes, metal fibers (i.e., stainless steel fibers), carbon powder, carbon fibers, carbon black, carbon nanotubes, or combinations thereof. Further, the conductive filler can be present in the polymer composition in an amount ranging from about 1% by weight to about 30% by weight, such as in an amount ranging from about 2.5% by weight to about 25% by weight, such as in an mount ranging from about 5% by weight to about 20% by weight based on the total weight of the polymer composition.

Further, the high flow polyoxymethylene polymer that is blended with the conductive filler prior to compounding the conductive filler composition with the plasticized, impact modified polyoxymethylene composition can have a melt flow rate of from about 2.5 grams per 10 minutes to about 55 grams per 10 minutes at 190° C. and a 2.16 kg load. The high flow polyoxymethylene can be present in the polymer composition in an amount ranging from about 1% by weight to about 30% by weight, such as in an amount ranging from about 2.5% by weight to about 25% by weight, such as in an amount ranging from about 5% by weight to about 20% by weight based on the total weight of the polymer composition.

In addition to the components discussed above, the polyoxymethylene composition and the conductive filler composition can each contain various additives such as a phenoxy resin, lubricants, antioxidants, UV light absorbers, light stabilizers, and formaldehyde scavengers. These components can each be present in the composition in an amount ranging from about 0.005% by weight to about 2% by weight, such as in an amount ranging from about 0.0075% by weight to about 1% by weight, such as in an amount ranging from about 0.01% by weight to about 0.5% by weight based on the total weight of the polymer composition.

As described above, the polymer composition of the present disclosure dramatically improves the electrostatic dissipative (ESD) capabilities of flexible polyoxymethylene. Of particular advantage, molded articles made from the polymer composition described above are well suited for use in fuel delivery parts in automobiles where ESD capabilities are required. As described above, the polymer composition of the present disclosure generally contains a (1) a plasticized, impact modified polyoxymethylene polymer composition having a relatively high amount of functional groups, such as hydroxyl groups and (2) a conductive filler composition.

### Plasticized, Impact Modified Polyoxymethylene Composition

The plasticized, impact modified polyoxymethylene composition comprises a polyoxymethylene having functional end groups. Generally, the preparation of the polyoxymethylene that is part of the plasticized, impact modified polyoxymethylene composition can be carried out by polymerization of polyoxymethylene-forming monomers, such as trioxane or a mixture of trioxane and dioxolane, in the presence of ethylene glycol as a molecular weight regulator. The polymerization can be effected as precipitation polymerization or in the melt, By a suitable choice of the polymerization parameters, such as duration of polymerization or amount of molecular weight regulator, the molecular weight and hence the MVR value of the resulting polymer can be adjusted. The above-described procedure for the polymerization can lead to polymers having comparatively small proportions of low molecular weight constituents. If a further reduction in the content of low molecular weight constituents were to be desired, this can be effected by separating off the low molecular weight fractions of the polymer after the deactivation and the degradation of the unstable fractions after treatment with a basic protic solvent. This may be a fractional precipitation from a solution of the stabilized polymer; polymer fractions of different molecular weight distribution being obtained.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2% by weight.

A heteropoly acid refers to polyacids formed by the condensation of different kinds of oxo acids through dehydration and contains a mono- or poly-nuclear complex ion wherein a hetero element is present in the center and the axe acid residues are condensed through oxygen atoms. Such a heteropoly acid is represented by the formula:

Hₓ[MₘM′ₙO_{z}]yH₂O

wherein

M represents an element selected from the group consisting of P, Si, Ge, Sn, As, Sb, U, Mn, Re, Cu, Ni, Ti, Co, Fe, Cr, Th or Ce,

M′ represents an element selected from the group consisting of W, Mo, V or Nb,

m is 1 to 10,

n is 6 to 40,

z is 10 to 100,

x is an integer of 1 or above, and

y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof.

Excellent results have been achieved with heteropoly acids selected from 12-molybdophosphoric acid (H₃PMo₁₂O₄₀) and 12-tungstophosphoric acid (H₃PW₁₂O₄₀) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfils the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

(ROOC)—(CH₂)ₙ₋(COOR′)

wherein

n is an integer from 2 to 12, preferably 3 to 6, and

R and R represent independently from each other an alkyl group having 1 to 4 carbon atoms, preferably selected from the group consisting of methyl, ethyl, n-propyl, iso-propyl, n-butyl, iso-butyl and tert-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

(ROOC)₂—CH—(CH₂)ₘ—CH—(COOR′)₂

wherein

m is an integer from 0 to 10, preferably from 2 to 4, and

R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butanetetracarboxylic acid tetraethyl ester or butanetetracarboxylic acid tetramethyl ester.

Specific examples of the alkyl ester of a polybasic carboxylic acid are dimethyl glutaric acid, dimethyl adipic acid, dimethyl pimelic acid, dimethyl suberic acid, diethyl glutaric acid, diethyl adipic acid, diethyl pimelic acid, diethyl suberic acid, diemethyl phthalic acid, dimethyl isophthalic acid, dimethyl terephthalic acid, diethyl phthalic acid, diethyl isophthalic acid, diethyl terephthalic acid, butantetracarboxylic acid tetramethylester and butantetracarboxylic acid tetraethylester as well as mixtures thereof. Other examples include dimethylisophthalate, diethylisophthalate, dimethylterephthalate or diethylterephthalate.

Preferably, the heteropoly acid is dissolved in the alkyl ester of the polybasic carboxylic acid in an amount lower than 5 weight percent, preferably in an amount ranging from 0.01 to 5 weight percent, wherein the weight is based on the entire solution.

In some embodiments, the polyoxymethylene composition described herein may contain other polyoxymethylene homopolymers and/or polyoxymethylene copolymers. Such polymers, for instance, are generally unbranched linear polymers which contain as a rule at least 80%, such as at least 90%, oxymethylene units. Such conventional polyoxymethylenes may be present in the plasticized, impact modified polyoxymethylene composition as long as the resulting mixture maintains the above amounts of hydroxyl terminated groups and the above amounts of low molecular weight constituents.

In one embodiment, the polyoxymethylene polymer has a content of terminal hydroxyl groups of at least 5 mmol/kg, such as at least 10 mmol/kg, such as at least 15 mmol/kg. In one embodiment, the terminal hydroxyl group content ranges from 18 to 50 mmol/kg.

As discussed above, in addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O— repeat units.

In addition to having a relatively high terminal hydroxyl group content, the polyoxymethylene polymer according to the present disclosure may have a relatively low amount of low molecular weight constituents. As used herein, low molecular weight constituents (or fractions) refer to constituents having molecular weights below 10,000 Daltons. For example, the polyoxymethylene polymer can contain low molecular weight constituents in an amount less than about 15% by weight, based on the total weight of the polyoxymethylene. In certain embodiments, for instance, the polyoxymethylene polymer may contain low molecular weight constituents in an amount less than about 10% by weight, such as less than about 5% by weight, such as in an amount less than about 3% by weight, such as even in an amount less than about 2% by weight.

Further, the polyoxymethylene polymer present in forming the plasticized, impact modified polyoxymethylene composition can generally have a melt volume rate (MVR) of less than 50 cm³/10 min, such as from about 1 to about 40 cm³/10 min, such as from about 2 to 20 cm³/10 min determined according to ISO 1133 at 190° C. and 2.16 kg.

It is to be understood that the term polyoxymethylene comprises both homopolymers of formaldehyde or its cyclic oligomers, such as trioxane or 1,3,5,7-tetraoxacyclooctane, and corresponding copolymers. For example the following components can be used in the polymerization process: ethyleneoxide, 1,2-propyleneoxide, 1,2-butyleneoxide, 1,3-butyleneoxide, 1,3-dioxane, 1,3-dioxolane, 1,3-dioxepane and 1,3,6-trioxocane as cyclic ethers as well as linear oligo- or polyformales, like polydioxolane or polydioxepane.

Further, polyoxymethylenes which are prepared by copolymerization of trioxane and the formal of trimethylolpropane (ester), of trioxane and the alpha, alpha and the alpha, beta-isomers of glyceryl formal (ester) or of trioxane and the formal of 1,2,6-hexantriol (ester) can be used in forming the functionalized polyoxymethylene.

Such polyoxymethylene homo- or copolymers are known per se to the person skilled in the art and are described in the literature

The amount of functionalized polyoxymethylene polymer (i.e., POM-OH) present in the polymer composition of the present disclosure can vary depending upon the particular application. In one embodiment, for instance, the polymer composition contains functionalized polyoxymethylene polymer in an amount ranging from about 30% by weight to about 95% by weight, such as in an amount ranging from about 40% by weight to about 90% by weight, such as in an amount ranging from about 50% by weight to about 85% by weight based on the total weight of the polymer composition.

The polymer composition further comprises at least one plasticizer. The plasticizer is a substance incorporated into the composition of the invention to increase its flexibility. The plasticizer reduces the melt viscosity and decreases the elastic modulus of the molded parts obtainable from the composition of the invention. The plasticizers which are useful for the polymer composition of the present disclosure are organic substances with low vapor pressures, which react physically with the components of the composition to form a homogeneous physical unit, whether it is by means of swelling or dissolving or any other. It has been found that an effective plasticizing effect could only be achieved in compositions which in addition to the polyoxymethylene comprise at least one impact modifier, especially a thermoplastic elastomer, as discussed in more detail below.

The plasticizer can have a molecular weight ranging from about 100 g/mol to about 1000 g/mol, such as from about 120 g/mol to about 800 g/mol, such as from about 150 g/mol to about 600 g/mol. However, in case of polymeric plasticizers such as polyesters, the average molecular weight can range from about 800 g/mol to about 10,000 g/mol, such as from about 1000 g/mol to about 7000 g/mol. Further, the plasticizer can have a melting point of less than about 200° C., such as less than about 180° C. Moreover, the plasticizer can be a liquid or have a solid amorphous phase within the range of about −20° C. to about 100° C.

In one embodiment, the plasticizer comprises aromatic esters, aromatic polyesters, aliphatic diesters, epoxides, sulfonamides, glycols, polyethers, polybutenes, polyesters, acetylated monoglycerides, alkyl citrates and organophosphates or combinations thereof. Preference is given to plasticizers which comprise an ester functionality. Therefore, in one embodiment, the plasticizer comprises adipates, sebacates, maleates, phthalates, trimellitates, benzoates or combinations thereof.

Examples of suitable phthalates are diisobutyl phthalate (DIBP), dibutyl phthalate (DBP), diisoheptyl phthalate (DIHP), L 79 phthalate, L711 phthalate, dioctyl phthalate, diisooctyl phthalate, dinonyl phthalate, diisononyl phthalate, diisodecyl phthalate, L911 phthalate, diundecyl phthalate, diisoundecyl phthalate, undecyl dodecyl phthalate, diisotridecyl phthalate (DTDP) and butyl benzyl phthalate (BBP).

Examples of adipates are dioctyl adipate, diisononyl adipate and diisodecyl adipate. An example for a trimellitate is trioctyl trimellitate. Phosphate esters can also be used. Suitable examples are tri-2-ethylhexyl phosphate, 2-Ethylhexyl diphenyl phosphate and tricresyl phosphate.

Preferred sebacates and azelates are di-2-ethylhexyl sebacate (DOS) and di-2-ethylhexyl azelate (DOZ).

Preferred polyester plasticizers are typically based on condensation products of propane- or butanediols with adipic acid or phthalic anhydride. The growing polymer chain of these polyesters may then be end-capped with an alcohol or a monobasic acid, although non-end-capped polyesters can be produced by strict control of the reaction stoichiometry.

Further preferred plasticizers are benzoates which are commercially available as JAYFLEX® MB10, BENZOFLEX® 2088, BENZOFLEX® LA-705, and BENXOFLEX® 9-88. Epoxide based plasticizers are preferably epoxidized vegetable oils.

Especially preferred plasticizers are aromatic benzene sulfonamides. Preference is given to benzene sulfonamides represented by the general formula (I):

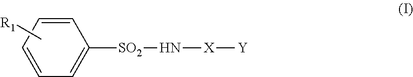

in which
R₁ represents a hydrogen atom, a C₁-C₄ alkyl group or a C₁-C₄ alkoxy group,
X represents a linear or branched C₂-C₁₀ alkylene group, or
a cycloaliphatic group, or
an aromatic group,
Y represents one of the groups OH or

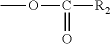

R₂ represents a C₁-C₄ alkyl group or an aromatic group, these groups optionally themselves being substituted by an OH or C₁-C₄ alkyl group.

The preferred aromatic benzenesulphonamides of formula (I) are those in which:

R₁ represents a hydrogen atom or a methyl or methoxy group,
X represents a linear or branched C₂-C₁₀ alkylene group or a phenyl group,
Y represents an OH or —O—CO—R₂ group,
R₂ representing a methyl or phenyl group, the latter being themselves optionally substituted by an OH or methyl group.

Mention may be made, among the aromatic sulphonamides of formula (I) which are liquid (L) or solid (S) at room temperature as specified below, of the following products, with the abbreviations which have been assigned to them:
N-(2-hydroxyethyl)benzenesulphonamide (L),
N-(3-hydroxypropyl)benzenesulphonamide (L),
N-(2-hydroxyethyl)-p-toluenesulphonamide (5),
N-(4-hydroxyphenyl)benzenesulphonamide (S),
N-[(2-hydroxy-1-hydroxymethyl-1-methyl)ethyl]benzenesulphonamide (L), N-[5-hydroxy-1,5-dimethylhexyl]benzenesulphonamide (S),
N-(2-acetoxyethyl)benzenesulphonamide (5),
N-(5-hydroxypentyl)benzenesulphonamide (L),
N-[2-(4-hydroxybenzoyloxy)ethyl]benzene-sulphonamide (S),
N-[2-(4-methylbenzoyloxy)ethyl]benzenesulphonamide (S),
N-(2-hydroxyethyl)-p-methoxybenzenesulphonamide (S) and
N-(2-hydroxypropyl)benzenesulphonamide (L).

The advantages introduced by the aromatic sulphonamides of formula (I) in the plasticization of the semi-crystalline polymers are many. For example, the high thermal stability of the sulphonamides makes it possible to incorporate them in polymers at high temperature without them substantially evaporating, which prevents losses of the product and atmospheric pollution. Further, they do not decompose at high temperature, which prevents unacceptable coloring of the polymer and allows them to act as plasticizer since they remain present intact in the polymer. It is consequently possible henceforth to use these plasticizers for processing techniques (injection molding, extrusion, extrusion blow-molding, rotational molding, and the like) at high temperatures and with long contact times. Their high compatibility with the abovementioned polyoxymethylene also promotes the development of their plasticizing properties, and their plasticizing effect is reflected by a large decrease in the mechanical torque developed by the molten medium during mixing of the plasticizer with the polymer as well as during any processing of these compositions, which represents a large decrease in the energy to be used during these operations. The plasticizing effect is also reflected by a fall in the glass transition temperature, which results in a decrease in the stiffness of the articles obtained starting with these compositions, which can be measured by the fall in the elastic modulus and by an improvement in the impact strength.

An especially preferred plasticizer is a sulfonamide, for example N-(n-butyl)benzene sulfonamide.

The plasticizer can be present in the polymer composition in an amount ranging from about 2.5% by weight to about 40% by weight, such as from about 5% by weight to about 35% by weight, such as from about 10% by weight to about 25% by weight based on the total weight of the polymer composition.

The polymer composition further comprises an impact modifier such as a thermoplastic elastomer. Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE-E), thermoplastic polyamide elastomers (TPE-A) and in particular thermoplastic polyurethane elastomers (TPE-U). The above thermoplastic elastomers have active hydrogen atoms which can be reacted with coupling reagents and/or the polyoxymethylene polymer. Examples of such groups are urethane groups, amido groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic polyurethane elastomer is used. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain dial with a diisocyanate to produce a polyurethane prepolymer having isocyanate end groups, followed by chain extension of the prepolymer with a diol chain extender. Representative long-chain dials are polyester diols such as poly(butylene adipate)diol, poly(ethylene adipate)diol and poly(ε-caprolactone)diol; and polyether dials such as poly(tetramethylene ether)glycol, poly(propylene oxide)glycol and poly(ethylene oxide)glycol, Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic dials such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

In one particular embodiment, a thermoplastic polyurethane elastomer is used that contains carbonate groups. The thermoplastic polyurethane elastomer, for instance, may have at least one soft segment containing carbonate groups.

Thermoplastic elastomers containing carbonate groups can be produced, in one embodiment, using a diol component that contains carbonate groups. For instance, the thermoplastic elastomer can be produced as described above by reacting together a polymer dial containing carbonate groups with an isocyanate and a chain extender. The polymer dial, for instance, may comprise a polycarbonate dial and/or a polyester polycarbonate

A polycarbonate dial may be produced by reacting a diol with a carbonate compound. The carbonate compound may comprise, for instance, a carbonate compound with alkyl groups, a carbonate compound with alkylene groups, or a carbonate compound containing aryl groups. Particular carbonate compounds include dimethyl carbonate, diethyl carbonate, ethylene carbonate, and/or diphenyl carbonate. A polyester polycarbonate, on the other hand, may be formed by reacting a diol with a carbonate compound as described above in the presence of a carboxylic acid.

As described above, the polycarbonate groups contained in the thermoplastic elastomer are generally referred to as soft segments. Thus, the polycarbonate groups have a tendency to lower the hardness of the thermoplastic elastomer. In one embodiment, for instance, the Shore A hardness of the thermoplastic elastomer is less than about 98, such as less than about 95, such as less than about 93 when tested according to ISO Test 868. The Shore A hardness of the material is generally greater than about 80, such as greater than about 85.

The amount of thermoplastic elastomer contained in the polymer composition can vary depending upon various factors. For instance, the thermoplastic elastomer is present in an amount ranging from about 5% by weight to about 50% by weight, such as in an amount ranging from about 10% by weight to about 40% by weight, such as in an amount ranging from about 15% by weight to about 30% by weight based on the total weight of the polymer composition.

In one embodiment, the thermoplastic elastomer may be coupled to the polyoxymethylene polymer of the present disclosure via the coupling agent as described above. The coupling agent can form bridging groups between the polyoxymethylene polymer and the thermoplastic elastomer. Further, the coupling agent may be capable of forming covalent bonds with the terminal hydroxyl groups on the polyoxymethylene polymer and with active hydrogen atoms on the thermoplastic elastomer. In this manner, the thermoplastic elastomer becomes coupled to the polyoxymethylene through covalent bonds.

When a thermoplastic elastomer is included in the composition of the present disclosure, the polyoxymethylene polymer, thermoplastic elastomer, and coupling agent can be melt blended in an extruder, and then various loadings of texturizing agents, such as glass fibers, can be added.

A coupling agent may be added to the composition to provide a linkage between the polyoxymethylene and other components that may be present in the composition, such as the plasticizer and the thermoplastic elastomer impact modifier discussed above. In principle any coupling agent which is capable to react with nucleophilic groups such as —OH or —NH₂ can be used.

For instance, the coupling agent can improve the compatibility of the texturizing agent with the polymer matrix. A suitable coupling agent is a polyisocyanate, preferably organic diisocyanate, more preferably a polyisocyanate selected from the group consisting of aliphatic diisocyanates, cycloaliphatic diisocyanates, aromatic diisocyanates and mixtures thereof.

A wide range of polyfunctional, such as trifunctional or bifunctional coupling agents, may be used. In one embodiment, the coupling agent comprises a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2′-, 2,4-, and 4,4′-diphenylmethane diisocyanate (MDI); 3,3′-dimethyl-4,4′-biphenylene diisocyanate (TODD; toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane, isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

The polymer composition generally contains the coupling agent in an amount from about 0.1% to about 10% by weight based on the total weight of the polymer composition. In one embodiment, for instance, the coupling agent is present in an amount ranging from about 0.2% by weight to about 5% by weight. In another embodiment, the coupling agent is present in an amount from about 0.5% to about 2.5% by weight. To ensure that the thermoplastic elastomer has been completely coupled to the polyoxymethylene polymer, in one embodiment, the coupling agent can be added to the polymer composition in molar excess amounts when comparing the reactive groups on the coupling agent with the amount of terminal hydroxyl groups on the polyoxymethylene polymer.

In addition to the POM-OH, plasticizer, impact modifier, and coupling agent discussed above, the polymer composition of the present disclosure can also optionally contain a stabilizer and/or various other known additives. These stabilizers and other additives can be combined with the POM-OH composition and/or the high flow polyoxymethylene/conductive filler composition. Such additives can include, for example, antioxidants, acid scavengers, UV stabilizers or heat stabilizers. In addition, the molding material or the molding may contain processing auxiliaries, for example adhesion promoters, lubricants, nucleating agents, demolding agents, fillers, reinforcing materials or antistatic agents and additives which impart a desired property to the molding material or to the molding.

For instance, in one embodiment, an ultraviolet light stabilizer may be present. The ultraviolet light stabilizer may comprise a benzophenone, a benzotriazole, or a benzoate. Particular examples of ultraviolet light stabilizers include 2,4-dihydroxy benzophenone, 2-hydroxy-4-methoxybenzophenone, 2-(2′-hydroxy-3′,5′-di-t-butylphenyl)benzotriazole, 2-(2′-hydroxy-3′-t-butyl-5′-methylphenyl)-5-chlorobenzotriazole, 2,4-dihydroxybenzophenone, 2-hydroxy-4-methoxybenzophenone, 2-hydroxy-4-octoxybenzophenone, and 5,5′-methylene bis(2-hydroxy-4-methoxybenzophenone); 2-(2′-hydroxyphenyl)benzotriazoles, e.g., 2-(2′-hydroxy-5′-methylphenyl)benzotriazole, 2-(2′-hydroxy-5′-t-octylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-3′,5′-dicumylphenyl)benzotriazole, and 2,2′-methylene bis(4-t-octyl-6-benzotriazolyl)phenol, phenylsalicylate, resorcinol monobenzoate, 2,4-di-t-butylphenyl-3′,5′-di-t-butyl-4′-hydroxybenzoate, and hexadecyl-3,5-di-t-butyl-4-hydroxybenzoate; substituted oxanilides, e.g., 2-ethyl-2′-ethoxyoxanilide and 2-ethoxy-4′-dodecyloxanilide; cyanoacrylates, e.g., ethyl-α-cyano-β,β-diphenylacrylate and methyl-2-cyano-3-methyl-3-(p-methoxyphenyl)acrylate or mixtures thereof. A specific example of an ultraviolet light absorber that may be present is UV 234, which is a high molecular weight ultraviolet light absorber of the hydroxyl phenyl benzotriazole class. The UV light absorber, when present, can be present in the polymer composition in an amount ranging from about 0.1% by weight to about 2% by weight, such as in an amount ranging from about 0.25% by weight to about 1% by weight based on the total weight of the polymer composition.

In one embodiment, the polymer composition may also include a formaldehyde scavenger, such as a nitrogen-containing compound. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Advantageous compounds of this nature are aminopyridine and compounds derived therefrom. Any of the aminopyridines is in principle suitable, for example 2,6-diaminopyridine, substituted and dimeric aminopyridines, and mixtures prepared from these compounds. Other advantageous materials are polyamides and dicyane diamide, urea and its derivatives and also pyrrolidone and compounds derived therefrom. Examples of suitable pyrrolidones are imidazolidinone and compounds derived therefrom, such as hydantoines, derivatives of which are particularly advantageous, and those particularly advantageous among these compounds are allantoin and its derivatives. Other particularly advantageous compounds are triamino-1,3,5-triazine (melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger can be a guanidine compound which can include an aliphatic guanamine-based compound, an alicyclic guanamine-based compound, an aromatic guanamine-based compound, a hetero atom-containing guanamine-based compound, or the like. The formaldehyde scavenger can pe present in the polymer composition in an amount ranging from about 0.005% by weight to about 2% by weight, such as in an amount ranging from about 0.0075% by weight to about 1% by weight based on the total weight of the polymer composition.

In one embodiment, the composition may also contain a nucleant. The nucleant, for instance, may increase crystallinity and may comprise an oxymethylene terpolymer. In one particular embodiment, for instance, the nucleant may comprise a terpolymer of butanediol diglycidyl ether, ethylene oxide, and trioxane. The nucleant can be present in the composition in an amount ranging from about 0.05% by weight to about 2% by weight based on the total weight of the polymer composition.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (IRGANOX® 1010, BASF), triethylene glycol bis[3-(3-tert-butyl-4-hydroxy-5-methylphenyl)propionate] (IRGANOX® 245, BASF), 3,3′-bis[3-(3,5-di-tert-butyl-4-hydroxyphenyl)propionohydrazide] (IRGANOX® MD 1024, BASF), hexamethylene glycol bis[3-(3,5-di-tert-butyl-4-hydroxyphenyl)propionate] (IRGANOX® 259, BASF), and 3,5-di-tert-butyl-4-hydroxytoluene (LOWINOX® BHT, Chemtura). The above compounds may be present in the polymer composition in an amount ranging from about 0.01% by weight to about 1% by weight based on the total weight of the polymer composition.

Light stabilizers that may be present in addition to the ultraviolet light stabilizer in the composition include sterically hindered amines. Hindered amine light stabilizers that may be used include oligomeric compounds that are N-methylated. For instance, another example of a hindered amine light stabilizer comprises ADK STAB LA-63 light stabilizer available from Adeka Palmarole. The light stabilizers, when present, can be present in the polymer composition in an amount ranging from about 0.1% by weight to about 2% by weight, such as in an amount ranging from about 0.25% by weight to about 1% by weight based on the total weight of the polymer composition.

In one embodiment, the composition may also contain one or more lubricants. The lubricant may comprise a polymer wax composition. Lubricants that may be included in the composition include, for instance, N,N′-ethylene bisstearamide or ethylene bis-stearamide (EBS) wax, which is based on monocarboxylic acids derived from naturally occurring vegetable oils. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. Lubricants can generally be present in the polymer composition in an amount ranging from about 0.005% by weight to about 2% by weight, such as in an amount ranging from about 0.0075% by weight to about 1% by weight, such as in an amount ranging from about 0.01% by weight to about 0.5% by weight based on the total weight of the polymer composition.

In addition to the above components, the polymer composition may also contain an acid scavenger. The acid scavenger may comprise, for instance, an alkaline earth metal salt. For instance, the acid scavenger may comprise a calcium salt, such as a calcium citrate. The acid scavenger may be present in an amount ranging from about 0.01% by weight to about 1% by weight based on the total weight of the polymer composition.

Further, the polymer composition may also contain a compatibilizer such as a phenoxy resin. Generally, the phenoxy resin can be present in the composition in an amount ranging from about 0.01% by weight to about 1% by weight based on the total weight of the polymer composition.

Any of the above additives can be added to the polymer composition alone or combined with other additives. In general, each additive is present in the polymer composition in an amount less than about 5% by weight, such as in an amount ranging from about 0.005% by weight to about 2% by weight, such as in an amount ranging from about 0.0075% by weight to about 1% by weight, such as from about 0.01% by weight to about 0.5% by weight based on the total weight of the polymer composition.

The plasticized, impact modified polyoxymethylene composition discussed above can be formed in to pellets for compounding with the conductive filler composition discussed below to yield a flexible polymer composition having ESD capabilities. The reaction of the components of the plasticized, impact modified polyoxymethylene composition is typically effected at temperatures of from about 100° C. to about 240° C., such as from about 150° C. to about 220° C., and the duration of mixing is typically from about 0.25 minutes to about 60 minutes.

### Conductive Filler Composition

The plasticized, impact modified polyoxymethylene composition is compounded with a conductive filler composition to form the polymer composition of the present disclosure that is flexible and has ESD capabilities. The conductive filler composition comprises a conductive filler and a high flow polyoxymethylene, both of which are discussed in more detail below.

The conductive filler can include conductive particles, powders, fibers or combinations thereof. For instance, the conductive filler may comprise metal powders, metal flakes, metal fibers (i.e., stainless steel fibers), carbon powder, carbon fibers, carbon black, carbon nanotubes, or combinations thereof.

Further, the conductive filler can be present in the polymer composition of the present disclosure in an amount ranging from about 1% by weight to about 30% by weight, such as in an amount ranging from about 2% by weight to about 25% by weight, such as in an amount ranging from about 5% by weight to about 20% by weight, based on the total weight of the polymer composition.

In addition to a conductive filler, the conductive filler composition can further comprises a polyoxymethylene, such as a high flow polyoxymethylene. The high flow polyoxymethylene is generally an unbranched linear polymer that contains at least 80%, such as at least 90%, of oxymethylene units (—CH₂O—). It should be understood that the term polyoxymethylene here encompasses homopolymers of formaldehyde or of its cyclic oligomers, such as trioxane or tetroxane, and also corresponding copolymers, terpolymers and the like.

Polyoxymethylene homopolymers are prepared conventionally by polymerizing anhydrous formaldehyde or the trimer, trioxane. Polyoxymethylenes of suitable molecular weight for use herein may be prepared by polymerizing trioxane in the presence of Lewis acid catalysts such as antimony fluoride or boron trifluoride.

As is well known, ex reactor polyoxymethylene is stabilized predominantly by either end capping (e.g., acetylation of terminal hemiacetal via ester or ether groups) or by hydrolysis.

In one embodiment, polyoxymethylene copolymers with a proportion of 60% to 99.9% of recurring units being oxymethylene interspersed with the balance of oxy(higher alkylene) groups can be used in the conductive filler composition. Oxy(higher alkylene) groups are introduced via cyclic ether or cyclic formal having at least two adjacent carbon atoms in the ring in addition to trioxane, such as via ethylene oxide 1,3-dioxolane with trioxane. Mention may be made of cyclic ethers ethylene oxide, propylene 1,2-oxide, butylene 1,2-oxide, butylene 1,3-oxide, 1,3-dioxane, 1,3-dioxolane, and 1,3-dioxepan, and also linear oligo- or polyformals, such as polydioxolane or polydioxepan as comonomers. The polyoxymethylene resins used herein have a number average molecular weight of at least 10,000 and I.V, of least 1.0 (at 25° C. in a 0.2 wt. % solution in hexafluoroisopropanol). Additionally, the polyoxymethylene copolymers have melting points of at least 150° C. and a weight average molecular weight ranging from about 5000 to about 200,000, such as from about 7000 to about 150,000, Particular preference is given to end-group-stabilized polyoxymethylene polymers which have carbon-carbon bonds at the ends of the chains. Useful high flow polyoxymethylene resins are crystalline, and have a melt flow rate of from about 2.5 to about 55 grams per 10 minutes at 190° C. and a 2.16 kg load, such as CELCON® having a melt flow rate of from about 9 grams per 10 minutes to about 45 grams per 10 minutes at 190° C. and a 2.16 kg load, such as from about 14 grams per 10 minutes to about 40 grams per 10 minutes at 190° C. and a 2.16 kg load, as measured in accordance with ASTM D1238-82.

The high flow polyoxymethylene can be present in the polymer composition of the present disclosure in an amount ranging from about 1% by weight to about 30% by weight, such as in an amount ranging from about 2% by weight to about 25% by weight, such as in an amount ranging from about 5% by weight to about 20% by weight, based on the total weight of the polymer composition.

In addition to the high flow polyoxymethylene and conductive fillers discussed above, the conductive filler composition can also include any of the stabilizers and additives discussed above in reference to the plasticized, impact modified polyoxymethylene composition.

Before being compounded with the plasticized, impact modified polyoxymethylene composition discussed above to form a uniform pellet product that can be formed into the shaped articles of the present disclosure, the conductive filler composition is prepared by continuous impregnation/coating of the conductive filler (i.e., fibers) using molten high flow polyoxymethylene in a metering die.

Further, although the polymer composition is described above as including a blend of pellets of a plasticized, impact modified polyoxymethylene composition with pellets of a conductive filler composition, it is to be understood that the components of the plasticized, impact modified polyoxymethylene composition and the conductive filler composition can be blended together at one time to form a single, uniform pelleted product, thus eliminating the need to form two separate pellet compositions that are blended together. Thus, the single, uniform pelleted product can comprise a first polyoxymethylene polymer having terminal groups, wherein at least about 25% of the terminal groups in the first polyoxymethylene polymer are functional groups; a plasticizer; an impact modifier; a conductive filler; and a second polyoxymethylene polymer. The first polyoxymethylene polymer can be present in an amount ranging from about 30% by weight to about 95% by weight, the plasticizer can be present in an amount ranging from about 2.5% by weight to about 40% by weight, the impact modifier can be present in an amount ranging from about 5% by weight to about 50% by weight, the conductive filler can be present in an amount ranging from about 1% by weight to about 30% by weight, and the second polyoxymethylene polymer can be present in an amount ranging from about 1% by weight to about 30% by weight, based on the total weight of the polymer composition. Further, the second polyoxymethylene polymer can have a melt flow rate of from about 2.5 grams per 10 minutes to about 55 grams per 10 minutes at 190° C. and a 2.16 kilogram load. In addition, the polymer composition can further comprise a coupling agent that is present in an amount ranging from about 0.1% by weight to about 10% by weight based on the total weight of the polymer composition.

An almost limitless variety of polymer articles may be formed from the polymer composition of the present disclosure. Shaped articles can be made from the disclosed polymer composition according to the present disclosure using various different processes. In one embodiment, for instance, the shaped articles can be formed through an extrusion process. For instance, the polymer composition can be extruded into a corrugated tube. In an alternative embodiment, the articles may be formed through a blow molding process. Other embodiments include injection molding and rotational molding.

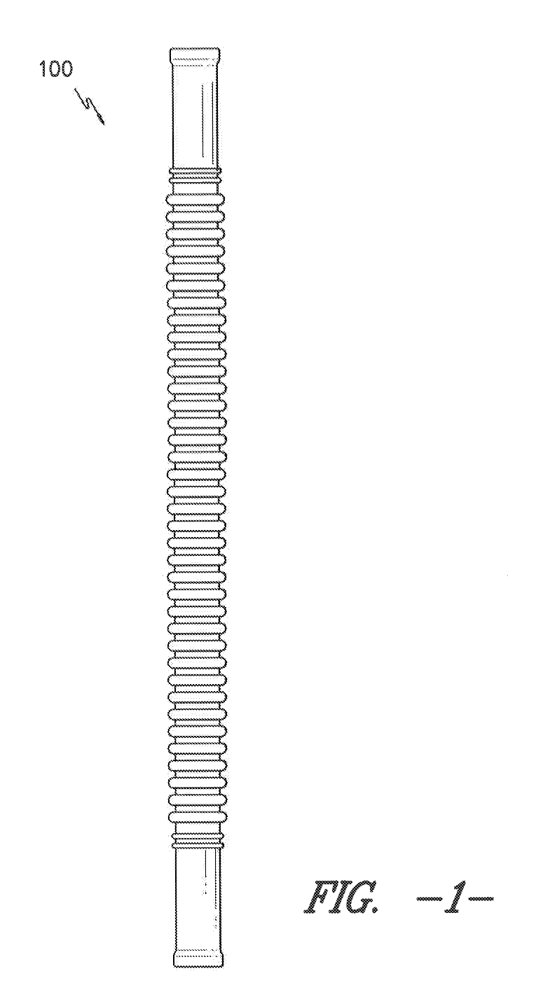

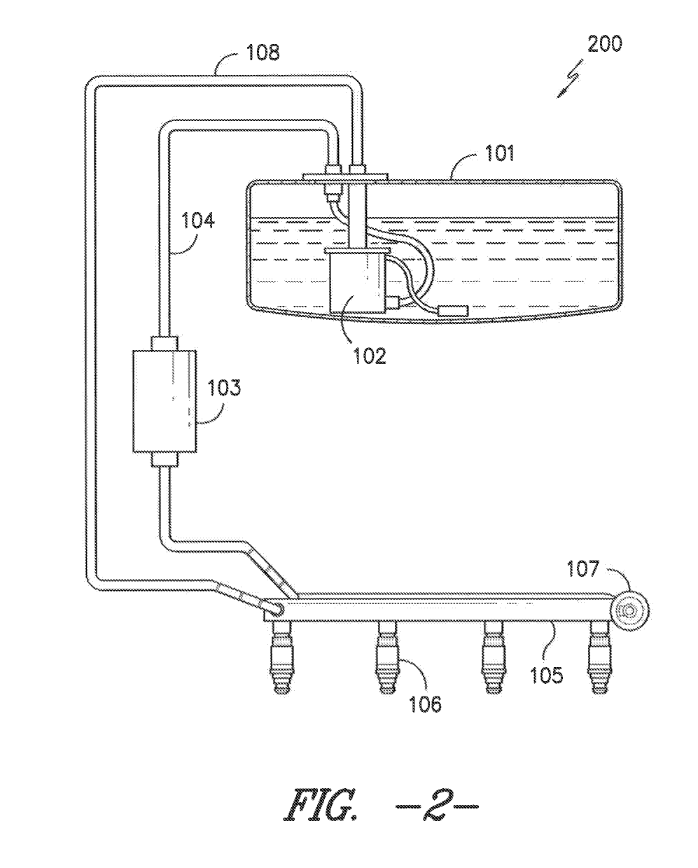

Further, the articles formed can include any pipes, tubes, hoses, lines, etc, where ESD capabilities are required, such as in fuel-based applications. For instance, FIGS. 1 and 2 show articles that can be formed from the polymer composition of the present disclosure. In FIG. 1, a corrugated tube 100 is shown that is formed by extrusion of pellets of the polymer composition of the present disclosure. Meanwhile, FIG. 2 shows an automotive fuel system 200 having a fuel tank 101, a fuel pump 102, a fuel filter 103, a delivery fuel line 104, a fuel rail 105, an injector 106, a pressure regulator 107, and a return fuel line 108. At least the delivery fuel line 104 and the return fuel line 108 can be formed from polymer compositions of the present disclosure so that the lines 104 and 108 are imparted with ESD capabilities to reduce the risk of sparking or explosion during the operation of the fuel system.

The present disclosure may be better understood with reference to the following example.

### Example

The following tests were conducted in order to demonstrate some of the advantages and benefits of forming molded articles from polymer compositions made according to the present disclosure. Two polymer compositions were formulated and molded into corrugated tubing. Then burst pressure, resistance, and static decay tests were performed on the tubing.

The following polymer compositions were tested, and the weight percentages of each of the components in each composition, based on the total weight of the polymer composition, are shown below in Table 1:
1. Comparative (plasticized, impact modified POM without stainless steel fibers-high flow POM)
2. Example (plasticized, impact modified POM compounded with stainless steel fiber-high flow POM)

For the example, which encompasses the polymer composition of the present disclosure, the components of composition A and the components of composition B were compounded separately, after which composition A and composition B were compounded together to form a uniform pellet product containing 85% by weight of composition A and 15% by weight of composition B, as shown below.

TABLE 1

| | | Weight % | Weight % |
|---|---|---|---|
| | Component | Comparative | Example |
| Composition A | POM with nominal 2.5 g/10 min melt flow rate and | 65.1 | 55.34 |
| | OH concentration of about 30 mmol/kg | | |
| | Thermoplastic Polyurethane | 18.0 | 15.3 |
| | 4,4′-diphenylmethane diisocyanate (MDI) | 0.7 | 0.595 |
| | Antioxidant | 0.2 | 0.17 |
| | Ultraviolet Light Absorber | 0.5 | 0.425 |
| | Light Stabilizer | 0.5 | 0.425 |
| | Plasticizer (Butyl Benzene Sulfonamide) | 15.0 | 12.75 |
| | Total | 100 | 85 |
| Composition B | Stainless Steel Fibers | — | 7.5 |
| | High Flow POM (45 g/10 min MFR) | — | 7.42 |
| | Ethylene-bis-stearamide (EBS) wax | — | 0.015 |
| | Dicyandiamide (Formaldehyde Scavenger) | — | 0.0075 |
| | Antioxidant | — | 0.0375 |
| | Phenoxy PKHH | — | 0.2025 |
| | Total | 0 | 15 |

After the pellets were formed of the comparative sample and the example, the pellets for each were extruded into a corrugated tube. After the tubes were formed, the burst pressure was tested for each of the tubes using water. The comparative sample tube showed a strength of about 34 bar (493 psi), while the example tube showed a similar strength of about 31 bar (450 psi), despite having stainless steel fibers as a component.

Next, nominal 194 millimeter lengths of corrugated tubing from the comparative sample and the example were tested for surface resistance (Ohmic losses) using a voltmeter and clamps with conductive elastomeric pads. The resistance reading for the comparative sample could not be determined as it was off the scale (greater than 1×10¹² Ohms). Meanwhile, the surface resistance of the example having stainless steel fibers was 1.7×10⁶ Ohms. Generally, a surface resistance value between 1×10⁴ Ohms and 1×10¹¹ Ohms indicates that the material is electrostatically dissipative. Because the tested example falls in this range, the corrugated tubing formed from the example polymer composition can be described as having ESD capabilities.

Additionally, static decay tests were performed on the comparative tube and example tube. The static decay test measures the rate of decay of a charged isolated object to 10% of its original value. The tubes were both charged to 5000 volts using a Monroe Charge Plate Analyzer Model 268A. Then the time was measured for the charge to reach 500 volts. Generally, a tube that exhibits ESD capabilities will reach a charge that is 10% of its original value within 2 seconds. The decay time for the comparative tube was 13.0 seconds, while the decay time for the example tube was 0.2 seconds, thus showing the ESD capabilities of the example tube, which is formed from the polymer composition of the present disclosure.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a plasticized, impact modified polyoxymethylene composition comprising a first polyoxymethylene polymer having terminal groups, wherein at least about 25% of the terminal groups in the first polyoxymethylene polymer are functional groups; a plasticizer; and an impact modifier; and
a conductive filler composition blended with the plasticized, impact, modified polyoxymethylene composition, the conductive filler composition comprising a conductive filler and a second polyoxymethylene polymer.

2. A polymer composition as defined in claim 1, wherein the functional groups are hydroxyl groups.

3. A polymer composition as defined in claim 1, wherein the first polyoxymethylene polymer is present in the polymer composition in an amount ranging from about 30% by weight to about 95% by weight based on the total weight of the polymer composition.

4. A polymer composition as defined in claim 1, wherein the plasticizer is an aliphatic or aromatic ester comprising an adipate, a sebacate, a maleate, a phthalate, a trimellitate, a benzoate, or combinations thereof.

5. A polymer composition as defined in claim 1, wherein the plasticizer is a sulfonamide.

6. A polymer composition as defined in claim 5, wherein the plasticizer is N-(n-butyl)benzene sulfonamide.

7. A polymer composition as defined in claim 1, wherein the plasticizer is present in the polymer composition in an amount ranging from about 2.5% by weight to about 40% by weight based on the total weight of the polymer composition.

8. A polymer composition as defined in claim 1, wherein the impact modifier comprises a thermoplastic elastomer.

9. A polymer composition as defined in claim 8, wherein the thermoplastic elastomer comprises a thermoplastic polyurethane elastomer.

10. A polymer composition as defined in claim 1, wherein the impact modifier is present in the polymer composition in an amount ranging from about 5% by weight to about 50% by weight based on the total weight of the polymer composition.

11. A polymer composition as defined in claim 1, wherein the conductive filler comprises a metal powder, metal flakes, metal fibers, carbon powder, carbon fibers, carbon black, carbon nanotubes, or combinations thereof.

12. A polymer composition as defined in claim 11, wherein the conductive filler comprises stainless steel fibers.

13. A polymer composition as defined in claim 11, wherein the conductive filler comprises carbon nanotubes.

14. A polymer composition as defined in claim 1, wherein the conductive filler is present in the polymer composition in an amount ranging from about 1% by weight to about 30% by weight based on the total weight of the polymer composition.

15. A polymer composition as defined in claim 1, wherein the second polyoxymethylene polymer has a melt flow rate of from about 2.5 grams per 10 minutes to about 55 grams per 10 minutes at 190° C. and a 2.16 kilogram load.

16. A polymer composition as defined in claim 1, wherein the second polyoxymethylene composition has a melt flow rate of from about 9 grams per 10 minutes to about 45 grams per 10 minutes at 190° C. and a 2.16 kilogram load.

17. A polymer composition as defined in claim 1, wherein the second polyoxymethylene composition is present in the polymer composition in an amount ranging from about 1% by weight to about 30% by weight based on the total weight of the polymer composition.

18. A polymer composition as defined in claim 1, wherein the plasticized, impact modified polyoxymethylene composition further comprises a coupling agent.

19. A polymer composition as defined in claim 18, wherein the coupling agent comprises an isocyanate.

20. A polymer composition as defined in claim 18, wherein the coupling agent is present in the composition in an amount ranging from about 0.1% by weight to about 10% by weight based on the total weight of the polymer composition.

21. A shaped article formed from the polymer composition as defined in claim 1, wherein the shaped article comprises a fuel line.

22. A shaped article formed from the polymer composition as defined in claim 1, wherein the shaped article comprises a tube.

23. A shaped article as defined in claim 22, wherein the shaped article comprises a corrugated tube.

24. A polymer composition comprising:
a first polyoxymethylene polymer having terminal groups, wherein at least about 25% of the terminal groups in the first polyoxymethylene polymer are functional groups;
a plasticizer;
an impact modifier;
a conductive filler; and
a second polyoxymethylene polymer.

25. A polymer composition as defined in claim 24, wherein the first polyoxymethylene polymer is present in an amount ranging from about 30% by weight to about 95% by weight, the plasticizer is present in an amount ranging from about 2.5% by weight to about 40% by weight, the impact modifier is present in an amount ranging from about 5% by weight to about 50% by weight, the conductive filler is present in an amount ranging from about 1% by weight to about 30% by weight, and the second polyoxymethylene polymer is present in an amount ranging from about 1% by weight to about 30% by weight, based on the total weight of the polymer composition.

26. A polymer composition as defined in claim 24, wherein the second polyoxymethylene polymer has a melt flow rate of from about 2.5 grams per 10 minutes to about 55 grams per 10 minutes at 190° C. and a 2.16 kilogram load.

27. A polymer composition as defined in claim 24, wherein the polymer composition further comprises a coupling agent present in an amount ranging from about 0.1% by weight to about 10% by weight based on the total weight of the polymer composition.
